(19) United States
(12) Patent Application Publication
(10) Pub. No.: US 2014/0234544 A1
(43) Pub. Date: Aug. 21, 2014

(54) SURFACE TREATMENT AGENT FOR ALUMINUM HEAT EXCHANGERS AND SURFACE TREATMENT METHOD

(71) Applicant: Nippon Paint Co., Ltd., Osaka-shi (JP)

(72) Inventors: Hiroshi Takada, Tokyo (JP); Hidekimi Hirasawa, Tokyo (JP); Kenji Tsuge, Tokyo (JP)

(73) Assignee: Noppon Paint Co., Ltd., Osaka-shi (JP)

(21) Appl. No.: 14/347,861

(22) PCT Filed: Sep. 20, 2012
(86) PCT No.: PCT/JP2012/074057

§ 371 Date: Mar. 27, 2014

(30) Foreign Application Priority Data
Sep. 30, 2011 (JP) 2011-218051

(51) Int. Cl. C09D 5/08; C23C 22/82

(52) U.S. Cl. CPC C09D 5/08; C23C 22/82
USPC 427/383.7; 524/408; 427/372.2

(57) ABSTRACT

A surface treatment agent for aluminum heat exchangers, which includes a zirconium element, vanadium element, fluorine element, aluminum element and an acrylic polymer, with the concentration of zirconium element in terms of zirconium being 100-100,000 ppm by mass, the concentration of vanadium element in terms of vanadium being 50-100,000 ppm by mass, the fluorine element concentration being 125-125,000 ppm by mass, the concentration of aluminum element in terms of aluminum being 5-10,000 ppm by mass and the concentration of the acrylic polymer being 100-100,000 ppm by mass. The surface treatment agent has a pH of 0.5-3, and suppresses odor generated from an aluminum heat exchanger, and the generation of white rust that deposits on the surface of an aluminum fin.

### TECHNICAL FIELD

The present invention relates to a surface treatment agent for an aluminum heat exchanger and a surface treatment method using the surface treatment agent for the aluminum heat exchanger.

### BACKGROUND ART

In aluminum heat exchangers, in general, a plurality of fins are disposed at a narrow interval and tubes for supplying a refrigerant are disposed at the fins in a complicated manner in order to maximize a surface area from the viewpoint of improvement in heat exchange rate. In the heat exchangers having the above-described complicated structure, when moisture in the air adheres to surfaces of the fins and tubes (hereinafter referred to as “fins and so forth”) as condensed water, the condensed water in some cases stays on the surface for a long time. In such cases, oxygen concentration cells are locally formed to cause a corrosion reaction to proceed, resulting in generation of rust.

Accordingly, as a technique for improving an antirust property of a surface of an aluminum material, there has been known a method of forming a chemical conversion film by bringing the surface into contact with a surface treatment agent. For example, as a surface treatment agent which is suitable for an aluminum heat exchanger, a surface treatment agent including a zirconium compound, a fluorine ion, a water-soluble resin, and an aluminum salt has been proposed (see Patent Document 1). It is described that an antirust property of a surface of an aluminum heat exchanger is improved by coating the surface with the surface treatment agent according to the technique.

A surface treatment agent including a vanadium compound and a metal compound containing a metal such as zirconium (see Patent Document 2); and a surface treatment agent containing a vanadium compound, titanium- or zirconium-based complex fluoride, and a resin has been proposed (see Patent Document 3). It is described that the antirust property is further improved since the vanadium compound having the excellent antirust property is contained in the surface treatment agent according to these techniques.

[Patent Document 1] Japanese Unexamined Patent Application, Publication No. 2001-303267

[Patent Document 2] Japanese Unexamined Patent Application, Publication No. 2002-30460

[Patent Document 3] Japanese Unexamined Patent Application, Publication No. 2002-60699

### DISCLOSURE OF THE INVENTION

### Problems to be Solved by the Invention

By the way, when an antirust property of the chemical conversion film formed on the aluminum heat exchanger is unsatisfactory, corrosion on the aluminum surface is caused to proceed due to moisture which adhered to the surface of the fins and so forth, resulting in generation of rust. Due to the rust generation, inorganic components are increased to generate odor or to adsorb odor. In a heat exchanger used for air conditioners, particularly, the odor generation is a considerable problem. Though a hydrophilic film is formed on the chemical conversion film in heat exchangers in general, the hydrophilic film does not have a gas barrier property and, therefore, is not capable of suppressing the odor. Therefore, in order to surpress the odor, it is necessary to suppress the corrosion on the aluminum surface by improving the antirust property of the chemical conversion film formed by using the surface treatment agent.

However, since the technique disclosed in Patent Document 1 does not use the vanadium compound which has the excellent antirust property, the antirust property thereof is not satisfactory as compared to the techniques using the vanadium compound.

Also, though each of the techniques disclosed in Patent Document 2 and Patent Document 3 uses the vanadium compound, the odor suppression is not discussed in the techniques at all since they are not for the heat exchanger.

Further, the conventional surface treatment for aluminum heat exchangers is performed in a manufacture line in which a pickling step and a following step for washing with water are generally performed for the purpose of removing impurities such as an oxide film formed on the aluminum surface. Since a large amount of waste water is generated in the pickling step and the step for washing with water, there has been a demand for reducing a cost and labor incurred by the treatments.

The present invention was accomplished in view of the above, and an object thereof is to provide a technique which is capable of imparting an excellent antirust property to an aluminum heat exchanger as compared to the conventional examples, suppressing odor caused by corrosion, and reducing a waste water amount caused by a surface treatment.

### Means for Solving the Problems

In order to achieve the above-described object, the present invention provides a surface treatment agent for an aluminum heat exchanger, including:

a zirconium element;

at least one vanadium element selected from the group consisting of vanadyl sulfate, vanadyl nitrate, and vanadyl phosphate;

an acrylic polymer obtainable by polymerizing a monomer including at least one kind selected from the group consisting of acrylic acid, methacrylic acid, and derivatives thereof;

an aluminum element; and

a fluorine element, in which

a concentration of the zirconium element is 100 to 100,000 mass ppm in terms of zirconium;

a concentration of the vanadium element is 50 to 100,000 mass ppm in terms of vanadium;

a concentration of the polymer is 100 to 100,000 mass ppm;

a concentration of the aluminum element is 5 to 10,000 mass ppm in terms of aluminum;

a concentration of the fluorine element is 125 to 125,000 mass ppm; and

a pH is 0.5 to 3.

In the surface treatment agent for the aluminum heat exchanger, preferably a ratio (Zr/Al) of the concentration of the zirconium element in terms of zirconium to the concentration of the aluminum element in terms of aluminum is 4/1 to 24/1;

a ratio (Zr/V) of the concentration of the zirconium element in terms of zirconium to the concentration of the vanadium element in terms of vanadium is 1/2 to 6/1;

a ratio (Zr/F) of the concentration of the zirconium element in terms of zirconium to the concentration of the fluorine element is 1/2 to 9/10;

a ratio (V/Al) of the concentration of the vanadium element in terms of vanadium to the concentration of the aluminum element in terms of aluminum is 4/1 to 24/1; and

a ratio ((Zr+V)/polymer) of a sum of the concentration of the zirconium element in terms of zirconium and the concentration of the vanadium element in terms of vanadium to the polymer concentration is 1/10 to 2.5/1.

Further, in order to achieve the above described object, the present invention provides a surface treatment method for an aluminum heat exchanger, including:

a chemical conversion treatment step for bringing the surface treatment agent for the aluminum heat exchanger of the present invention into contact with an aluminum heat exchanger having an oxide film on a surface; and

a first drying step for forming a chemical conversion film on the surface by heating and drying the aluminum heat exchanger which underwent the chemical conversion treatment step.

Preferably, the surface treatment agent for the aluminum heat exchanger is brought into contact with the aluminum heat exchanger in such a manner that a content of the zirconium element is 1 to 1,000 (mg/m²) and a content of the vanadium element is 1 to 1,000 (mg/m²) in the chemical conversion film in the chemical conversion treatment step.

Preferably, the surface treatment method further comprises a hydrophilization treatment step for bringing the aluminum heat exchanger which underwent the first drying step into contact with a hydrophilization treatment agent; and

a second drying step for forming a hydrophilic film on a surface of the chemical conversion film by drying a hydrophilization treatment agent film formed on the surface of the chemical conversion film in the hydrophilization treatment step.

### Effects of the Invention

According to the present invention, a surface treatment agent and a surface treatment method for an aluminum heat exchanger capable of imparting an excellent antirust property and an excellent deodorizing property to the aluminum heat exchanger are provided.

### Preferred Mode for Carrying Out the Invention

Hereinafter, one embodiment of the present invention will be described. It should be understood that the present invention is not limited to the following embodiment.

A surface treatment agent for the aluminum heat exchanger according to the present embodiment (sometimes referred to as “surface treatment agent of the present embodiment” in the present specification) includes: a zirconium element, a specific vanadium element, a fluorine element, an aluminum element, a polymer (hereinafter sometimes referred to as “acrylic polymer”) obtainable by polymerizing a monomer including at least one kind selected from the group consisting of acrylic acid, methacrylic acid, and derivatives thereof, in which a concentration of the zirconium element is 100 to 100,000 mass ppm in terms of zirconium; a concentration of the vanadium element in terms of vanadium is 50 to 100,000 mass ppm; a concentration of the fluorine element is 125 to 125,000 mass ppm; a concentration of the aluminum element in terms of aluminum is 5 to 10,000 mass ppm; a concentration of the acrylic polymer is 100 to 100,000 mass ppm; and a pH is 0.5 to 3.

[Heat Exchanger]

The aluminum heat exchanger to be treated with the surface treatment agent of the present embodiment is suitably used for automotive air conditioners. As used herein, “aluminum” means aluminum or an aluminum alloy (hereinafter simply referred to as “aluminum”).

As described above, a plurality of fins are disposed at a narrow interval and tubes for supplying a refrigerant are disposed at the fins in a complicated manner in the aluminum heat exchanger in order to maximize a surface area from the viewpoint of improvement in heat exchange rate.

[Surface Treatment Agent for Aluminum Heat Exchanger]

The surface treatment agent of the present embodiment is a coating type chemical conversion treatment agent including a zirconium element, vanadium element, a fluorine element, an aluminum element, and an acrylic polymer. The coating type chemical conversion treatment agent is used in a method including bringing the surface treatment agent into contact with a metal surface and drying without washing away the surface treatment agent with water. Heretofore, a pickling step for removing an oxide film on the surface and a step for washing with water which is performed after the pickling step are necessarily performed before bringing the surface treatment agent into contact with the surface of the aluminum heat exchanger in order to impart an antirust property. However, with the use of the surface treatment agent of the present invention, the oxide film on the surface is removed by bringing the surface treatment agent into contact with the surface of the aluminum heat exchanger. Therefore, it is no longer necessary to provide the pickling step and the subsequent step for washing with water.

The surface treatment agent of the present embodiment is obtained by dissolving a zirconium compound, a vanadium compound, and an aluminum compound into water. In the case where the zirconium compound and the like do not contain any fluorine ion, a fluorine compound is used. In the chemical conversion treatment agent, a concentration of the zirconium element represents a zirconium content (a concentration in terms of the metal element) in the chemical conversion treatment agent; a concentration of the vanadium element represents a vanadium content (a concentration in terms of the metal element) in the chemical conversion treatment agent; a concentration of the fluorine element represents a fluorine content (a concentration in terms of the element) in the chemical conversion treatment agent; and a concentration of the aluminum element represents an aluminum content (a concentration in terms of the metal element) in the chemical conversion treatment agent.

A zirconium ion supplied from the zirconium element imparts the antirust property to a chemical conversion film to be formed on the surface of the aluminum heat exchanger. Particularly, according to the surface treatment agent of the present embodiment, the chemical conversion film having excellent antirust property is formed.

Examples of a source of the zirconium element include fluorozirconic acid, lithium, sodium, potassium, and ammonium salts of fluorozirconic acid, zirconium sulfate, zirconyl sulfate, zirconium nitrate, zirconyl nitrate, zirconium fluoride, zirconium carbonate, zirconium hydrogen fluoride, and the like, and these may be used alone or in combination of two or more kinds thereof. In the case of using the zirconium compound containing fluorine, a fluorine ion is supplied. Therefore, it is not necessary to additionally use the fluorine element.

The concentration of the zirconium element contained in the surface treatment agent of the present embodiment may be 100 to 100,000 mass ppm, preferably 750 to 12,000 mass ppm, in terms of zirconium. When the concentration is less than 100 mass ppm, the antirust property of the chemical conversion film and adhesiveness to the hydrophilic film can be deteriorated in some cases. On the other hand, when the concentration exceeds 100,000 mass ppm, stability of the surface treatment agent is deteriorated.

A vanadium ion supplied from the vanadium element is the component which improves the antirust property of the chemical conversion film in combination with the zirconium ion. Further, the vanadium element is the component which promotes etching of the surface of the aluminum heat exchanger. The etching power is strong when the pH of the surface treatment agent is 0.5 to 3, and the oxide film which is formed on the surface of the aluminum heat exchanger is removed when the pH of the surface treatment agent is within the range. More specifically, since the etching is capable of dissolving a considerably large amount of aluminum and of uniformizing the surface of the aluminum heat exchanger as compared to etching with a surface treatment agent which does not contain any vanadium element, the etching enables to form a uniform chemical conversion film, thereby attaining a favorable antirust property. When the chemical conversion treatment is repetitively performed on the aluminum heat exchanger by using the surface treatment agent of the present embodiment in the case of forming the chemical conversion film on the surface by dipping the aluminum heat exchanger into the surface treatment agent, the aluminum ion concentration in the surface treatment agent is increased to diminish the etching power. However, the etching power enhanced by the vanadium element is not subject to the influence of the aluminum ion concentration increase and maintains the property.

As a source of the vanadium element, at least one compound selected from the group consisting of vanadyl sulfate, vanadyl nitrate, and vanadyl phosphate is used. Thus, it is possible to adjust the pH of the surface treatment agent of the present embodiment to the range of 0.5 to 3 and to etch a surface of a steel plate. In the case where a vanadium element other than those described above such as ammonium methavanadate and acetonate vanadate is used, the vanadium element cannot stably exist at the pH of the surface treatment agent of the present embodiment to undesirably cause a problem of aggregation or the like. On the other hand, when the pH of the surface treatment agent is set to a value which does not cause the aggregation, the oxide film and the like may not be removed to deteriorate the antirust property and, therefore, to generate odor. In the present embodiment, it is most preferable to use vanadyl sulfate.

The concentration of the vanadium element contained in the surface treatment agent of the present embodiment may be 50 to 100,000 mass ppm, preferably 500 to 9,000 mass ppm, in terms of vanadium. The chemical conversion film has a high antirust property when the concentration is within the above-specified range.

A ratio (Zr/V) of the concentration of the zirconium element in terms of zirconium to the concentration of the vanadium element in terms of vanadium may preferably be 1/2 to 6/1. The ratio (Zr/V) of 1/2 or more is preferred since the ratio enables to attain the favorable antirust property and deodorizing property, and the ratio (Zr/V) of 6/1 or less is preferred since the ratio ensures the etching power. More preferably, the ratio is 1/1 to 5/1.

The fluorine element is the component which promotes the etching of the surface of the aluminum heat exchanger at an initial stage. The fluorine element is supplied from the fluorine compound and the zirconium compound containing fluorine. Examples of a source of the fluorine element include hydrofluoric acid, ammonium fluoride, ammonium hydrogen fluoride, sodium fluoride, sodium hydrogen fluoride, and the like.

The concentration of the fluorine element to be contained in the surface treatment agent of the present embodiment may be 125 to 125,000 mass ppm, preferably 950 to 15,000 mass ppm. When the concentration of the fluorine element is 125 mass ppm or more, the effect of ensuring the etching power at the initial stage is attained, while fluorine is adsorbed by the chemical conversion film to cause deterioration in antirust property when the concentration exceeds 125,000 mass ppm.

A ratio (Zr/F) of the concentration of the zirconium element in terms of zirconium to the concentration of the fluorine element may preferably be 1/2 to 9/10. The ratio (Zr/F) of 1/2 or more is preferred since the ratio enables to attain the favorable antirust property, and the ratio (Zr/F) of 9/10 or less is preferred since the ratio ensures the etching power.

An aluminum ion supplied from the aluminum element is the component which promotes a crosslinking reaction of the surface treatment agent formed on the surface of the aluminum heat exchanger. Further, the aluminum ion is combined with a fluorine ion in a free state to form a fluoroaluminum to suppress deterioration in antirust property which can be caused when the chemical conversion film is dissolved by the fluorine ion. In the case of the coating type chemical conversion treatment agent as is the case with the surface treatment agent of the present embodiment, since the step for washing with water is not performed after bringing the chemical conversion treatment agent into contact with the surface of the aluminum heat exchanger, the fluorine ion remains in the chemical conversion film to deteriorate the antirust property of the chemical conversion film. However, the problem is suppressed owing to the presence of the aluminum ion.

Examples of a source of the aluminum element include aluminate such as aluminum nitrate, aluminum sulfate, aluminum fluoride, aluminum oxide, alum, aluminum silicate, and sodium aluminate and a fluoroaluminum salt such as sodium fluoroaluminate.

The concentration of the aluminum element to be contained in the surface treatment agent of the present embodiment may be 5 to 10,000 mass ppm, preferably 50 to 500 mass ppm, in terms of aluminum. When the concentration is less than 5 mass ppm, the antirust property of the chemical conversion film is deteriorated. On the other hand, a sludge can be generated in the treatment liquid when the concentration exceeds 10,000 mass ppm.

A ratio (Zr/Al) of the concentration of the zirconium element in terms of zirconium to the concentration of the aluminum element in terms of aluminum may preferably be 4/1 to 24/1. The ratio (Zr/Al) of 4/1 or more is preferred since the ratio enables to attain the favorable antirust property, and the ratio (Zr/Al) of 24/1 or less is preferred since the ratio ensures stability of the surface treatment agent. More preferably, the ratio is 8/1 to 20/1.

A ratio (V/Al) of the concentration of the vanadium element in terms of vanadium to the concentration of the aluminum element in terms of aluminum may preferably be 4/1 to 24/1. The ratio (V/Al) of 4/1 or more is preferred since the ratio enables to attain the favorable antirust property, and the ratio (V/Al) of 24/1 or less is preferred since the ratio ensures stability of the surface treatment agent. More preferably, the ratio is 4/1 to 20/1.

The acrylic polymer obtained by polymerizing the monomer including at least one kind selected from the group consisting of acrylic acid, methacrylic acid, and derivatives thereof is crosslinked with a metal such as zirconium, vanadium, and aluminum by heating and drying, to strengthen the chemical conversion film and to immobilize the zirconium, vanadium, aluminum, and the like in the chemical conversion film, thereby enhancing the antirust property of the chemical conversion film. As described later in this specification, the acrylic polymer suppresses the odor which is caused by the metal such as zirconium. Since the surface treatment agent for the present embodiment has the low pH of 0.5 to 3, it is necessary to use at least one kind selected from the group consisting of acrylic acid, methacrylic acid, and derivatives thereof as the monomer. An acrylic polymer formed of an acrylic monomer having at least one carboxyl group in a molecule has adhesiveness to the hydrophilic film and attains the favorable antirust property.

The acrylic polymer may be a homopolymer or a copolymer. In the surface treatment agent of the present embodiment, polyacrylic acid may preferably be used as the acrylic polymer. Since the polyacrylic acid has a lower pH as compared to polyvinyl alcohol and the like, it does not cause aggregation of the surface treatment agent of the present embodiment having the low pH. Also, for the purposes of adjusting a viscosity and the like of the surface treatment agent of the present embodiment, a plurality of kinds of the acrylic polymers may be used, or the acrylic polymers of an identical kind having different molecular weights may be used in combination.

The concentration of the acrylic polymer to be contained in the surface treatment agent of the present embodiment may be 100 to 100,000 mass ppm, preferably 5,000 to 20,000 mass ppm. When the concentration is less than 100 mass ppm, the adhesiveness to the hydrophilic film can be insufficient in some cases. On the other hand, when the concentration exceeds 100,000 mass ppm, a viscosity of the surface treatment agent is increased to deteriorate workability.

A ratio ((Zr+V)/acrylic polymer) of a sum of the concentration of the zirconium element in terms of zirconium and the concentration of the vanadium element in terms of vanadium to the acrylic polymer concentration may preferably be 1/10 to 2.5/1. The ratio ((Zr+V)/acrylic polymer) of 0.1 or more is preferred since the ratio enables to attain the favorable antirust property and deodorizing property, and the ratio ((Zr+V)/acrylic polymer) of 2.5 or less is preferred since the ratio ensures the adhesiveness to the hydrophilic film. More preferably, the ratio is 1/5 to 2/1.

The pH of the surface treatment agent of the present embodiment is 0.5 to 3. By setting the pH of the surface treatment agent to the low value as specified above, the effect of etching the surface of the aluminum heat exchanger with the vanadium element is enhanced. Also, by setting the pH to the above-specified range, zirconium is efficiently precipitated on a surface interface of the aluminum heat exchanger to uniformize the film, thereby attaining the favorable antirust property. Particularly, according to the present invention, the chemical conversion film is capable of maintaining the considerably excellent antirust property for a long time. A more preferred range of the pH is 1.5 to 2. When the pH is adjusted to 0.5 to 3 in the case of using a reactive chemical conversion treatment agent as the surface treatment agent, excessive etching occurs to make it difficult to form the chemical conversion film. The pH of the surface treatment agent may be adjusted by using an ammonium solution or nitric acid.

The surface treatment agent of the present embodiment is the coating type chemical conversion treatment agent as described above. As chemical treatment agents other than the coating type chemical conversion treatment agent, the reactive chemical conversion treatment agent is known. In the case of the reactive chemical conversion treatment agent, a pH of the chemical conversion treatment agent should be set to a value near a sedimentation pH of a metal such as the zirconium ion. Since the sedimentation pH of the metal is about 4, the reactive chemical conversion treatment agent makes it difficult to enhance the effect of etching with the vanadium element by adjusting the pH to 0.5 to 3.

The surface treatment agent of the present embodiment may comprise a zinc element in addition to the above-described essential components. A zinc ion supplied from the zinc element is combined with a free fluorine ion to prevent the free fluorine ion from deteriorating the antirust property and the like of the chemical conversion film. Also, the zinc ion promotes the crosslinking reaction between zirconium and the like and the acrylic polymer. Examples of a source of the zinc element include zinc nitrate, zinc carbonate, zinc sulfate, zinc oxide, and the like. Further, in the case where the zinc element is included, a concentration of the zinc element in the surface treatment agent may preferably be 5 to 1,000 mass ppm. The free fluorine ion means a fluorine ion which keeps activity.

Further, the surface treatment agent of the present embodiment may include a magnesium element. A magnesium ion supplied from the magnesium element is combined with the free fluorine ion to prevent the free fluorine ion from deteriorating the antirust property and the like of the chemical conversion film. Also, the magnesium ion promotes the crosslinking reaction between zirconium and the like and the acrylic polymer. Examples of a source of the magnesium element include magnesium hydroxide, magnesium phosphate, and the like. In the case where the magnesium element is included, a concentration of the magnesium element in the surface treatment agent may preferably be 5 to 1,000 mass ppm.

The surface treatment agent of the present embodiment may include a compound which supplies manganese, cerium, calcium, copper, iron, silicon, or the like, a phosphorus compound such as phosphonic acid, phosphoric acid, and condensed phosphoric acid, polyallylamine and various silane coupling agents such as amino silane and epoxy silane for improvement in adhesiveness, and the like.

[Surface Treatment Method]

A surface treatment method of the present embodiment includes a chemical conversion treatment step for bringing the surface treatment agent of the present embodiment into contact with an aluminum heat exchanger having an oxide film on a surface; and a first drying step for forming a chemical conversion film on the surface by drying a surface treatment agent film formed on the aluminum heat exchanger in the chemical conversion treatment step.

The surface treatment method of the present embodiment may be provided with a hot water washing step for washing the surface of the aluminum heat exchanger and a degreasing step for degreasing the surface of the aluminum heat exchanger which are performed before the chemical conversion treatment step and for the purpose of removing contaminants and so forth which adhered to the aluminum heat exchanger. In the case of performing the hot water washing step, hot water of 40° C. to 90° C. may preferably be used.

Further, it is unnecessary to provide the surface treatment method of the present embodiment with a pickling step for removing the oxide film on the surface of the aluminum heat exchanger and a step for washing with water performed after the pickling step.

The chemical conversion treatment step is the step for forming the surface treatment agent film on the surface of the aluminum heat exchanger by bringing the surface treatment agent of the present embodiment into contact with the aluminum heat exchanger.

In the chemical conversion treatment step, a method for bringing the surface treatment agent of the present embodiment into contact with the aluminum heat exchanger is not particularly limited. Any method such as spraying and dipping may be employed, but it is preferable to perform the chemical conversion treatment step by the dipping since the aluminum heat exchanger has the complicated shape as described above. Also, a temperature of the surface treatment agent in the chemical conversion treatment step may preferably be 5° C. to 40° C. Further, a time to be spent for performing the chemical conversion treatment step may preferably be 5 to 600 seconds, more preferably 10 to 300 seconds. The surface treatment agent film which is formed by the chemical conversion treatment step performed under these conditions satisfying the above-described requirements is capable of forming the chemical conversion film having the excellent antirust property and moisture resistance.

Since the surface treatment agent of the present embodiment is used in the chemical conversion treatment step, the oxide film and the like on the surface of the aluminum heat exchanger are removed by the vanadium element contained in the surface treatment agent, and etching of the surface is promoted. Therefore, since it is unnecessary to provide the pickling step and the step for washing with water performed after the pickling step according to the surface treatment method of the present embodiment, a reduction of a waste water amount is realized. The aluminum eluted by the etching promotion effect by the vanadium element increases a pH near the surface of the aluminum heat exchanger. As a result, the pH near the surface approaches to the pH at which the metal ions such as zirconium ion are sedimented to allow the metals such as zirconium to exist dominantly on a side of the surface of the aluminum heat exchanger. When the metals such as zirconium exist dominantly on the side of the surface of the aluminum heat exchanger, the metals such as zirconium are covered with the hardened acrylic polymer, thereby attaining suppression of generation of odor which can be otherwise caused by the metals such as zirconium.

Further, by adjusting a deposition amount of the surface treatment agent film through adjustment of the concentrations of the components in the chemical conversion treatment agent in the chemical conversion treatment step, it is possible to adjust a content of the zirconium element, a content of the vanadium element, and the like in the chemical conversion film to be formed on the surface of the aluminum heat exchanger after the first drying step described later in the specification. In the surface treatment method of the present embodiment, it is preferable to bring the surface treatment agent of the present embodiment into contact with the aluminum heat exchanger in such a manner that the content of the zirconium element in the chemical conversion film is 1 to 1,000 (mg/m²) and the content of the vanadium element is 1 to 1,000 (mg/m²). When the content of the zirconium element and the content of the vanadium element in the chemical conversion film are settled within the above-specified ranges, the effect attained by the zirconium element and the effect attained by the vanadium element are satisfactorily high. A more preferred range of the content of the zirconium element in the chemical conversion film is 3 to 200 (mg/m²), and a more preferred range of the content of the vanadium element is 3 to 200 (mg/m²).

The first drying step is the step for forming the chemical conversion film on the surface of the aluminum heat exchanger by drying the surface treatment agent film formed on the surface in the chemical conversion treatment step. The acrylic polymer is heated and dried in the first drying step to be crosslinked with the metals such as zirconium, vanadium, and aluminum, thereby immobilizing the metals such as zirconium in the chemical conversion film.

A drying temperature and a drying time in the first drying step are not particularly limited, and the drying temperature may preferably be 100° C. to 220° C., more preferably 150° C. to 200° C. The drying time may preferably be 10 to 60 minutes. A film formation property tends to be insufficient when the drying temperature is less than 100° C., while hydrophilicity durability tends to be deteriorated when the drying temperature exceeds 220° C.

During the drying in the first drying step, the metals such as zirconium and vanadium in the surface treatment agent film tend to be sedimented on the surface of the aluminum heat exchanger since the specific gravities of the metals are large. This is one of the factors of the segregation of the metals such as zirconium and vanadium on the surface of the aluminum heat exchanger. The metals such as zirconium and vanadium are segregated in the chemical conversion film as described above, and the segregated metals are covered with the acrylic polymer so that the generation of the odor otherwise caused by the metals such as zirconium is suppressed as described above.

In the surface treatment method of the present embodiment, it is preferable to perform a hydrophilization treatment step after the first drying step. The hydrophilization treatment step is the step for bringing the aluminum heat exchanger which underwent the first drying step into contact with a hydrophilization treatment agent, and the hydrophilization treatment agent film is formed on the chemical conversion film by this step.

Conventional hydrophilization treatment agents are usable as the hydrophilization treatment agent to be used in the hydrophilization treatment step without particular limitation, but the following hydrophilization treatment agent may preferably be used in the present embodiment.

The preferred hydrophilization treatment agent to be used in the surface treatment agent of the present embodiment is the one in which silica particles coated with a vinyl alcohol-based polymer are dispersed into a water medium.

Examples of the silica particles include fumed silica, colloidal silica, and the like. Among the above, the fumed silica is produced by subjecting halosilane such as trichlorosilane and tetrachlorosilane into high temperature hydrolysis in a gas phase and is a particulate having a large surface area. The colloidal silica is obtainable by dispersing acid- or alkali-stable silica sol into water. A volume average particle diameter of the silica particles may preferably be 5 to 100 nm, more preferably 7 to 60 nm. The hydrophilicity is deteriorated due to deficiency of irregularity of the treatment film when the volume average particle diameter of less than 5 nm, while workability tends to be deteriorated due to generation of aggregates having a large particle diameter in the treatment agent when the volume average particle diameter exceeds 100 nm. The volume average particle diameter was measured by diluting a part of the hydrophilization treatment agent with deionized water and using a dynamic light scattering measurement device (ELS-800, Otsuka Electronics Co., Ltd.).

As a typical example of the vinyl alcohol-based polymer, polyvinyl alcohol (PVA) obtainable by saponifying a vinyl acetate polymer is contemplated. As the PVA, those having a high saponification degree are preferred, and the one having a saponification degree of 98% or more is particularly preferred. Also, a modified product of PVA such as those obtained by substituting a part of a hydroxyl group with an alkyl group such as a propyl group and a butyl group is usable as the vinyl alcohol-based polymer. Further, when required, another hydrophilic polymer such as a hydroxyl group-containing acrylic resin, polyacrylic acid, polyvinyl sulfonic acid, polyvinyl imidazole, polyethylene oxide, polyamide, and water-soluble nylon in an amount of 50 mass % or less relative to PVA may be used in combination.

In order to produce the hydrophilization treatment agent, the vinyl alcohol-based polymer (and another hydrophilic polymer as required: hereinafter simply referred to as vinyl alcohol-based polymer) is firstly dissolved or dispersed in such a manner that an amount thereof is 0.3 to 17.5 mass %, preferably 0.5 to 5 mass %, relative to the hydrophilization treatment agent. Next, the silica particles in an amount of 0.3 to 17.5 mass %, preferably 0.5 to 5 mass %, relative to the hydrophilization treatment agent is added to the solution or dispersion.

As another preparation method, the silica particles are dispersed into a vinyl alcohol-based polymer solution having a solid content concentration of 5 to 50 mass % of the silica particles to coat the silica particles with the vinyl alcohol-based polymer, and then the vinyl alcohol-based polymer solution is added for adjusting the concentration.

A sum of contents of the silica particles and the vinyl alcohol-based polymer in the hydrophilization treatment agent may preferably be 0.2 to 25 mass %, more preferably 1 to 5 mass %. A mass ratio between the silica particles and the vinyl alcohol-based polymer may preferably be 30:70 to 70:30, more preferably 40:60 to 60:40. The effects of hydrophilicity durability and deodorizing property are not exhibited when the sum of the vinyl alcohol-based polymer and the silica particles is less than 0.2 mass %, while a viscosity is increased to deteriorate the coating workability when the sum exceeds 25 mass %. When the mass ratio between the silica particles and vinyl alcohol-based polymer is out of the range of 30:70 to 70:30, a film formation property is insufficient to cause detachment of the film, and dusty odor is generated from silica and the base material when the ratio of the silica particles is higher. When the ratio of the vinyl alcohol-based polymer is higher, the hydrophilicity is deteriorated.

As described above, when the vinyl alcohol-based polymer and the silica particles are mixed, aggregation occurs due to an interaction between them. Therefore, the aggregates are forcibly dispersed by using an ultrasonic disperser, a minute medium disperser, or the like. As the disperser, a mixer or the like which is used for simple stirring and dispersing is not capable of dispersing the aggregates, and it is necessary to use a disperser having a violent stirring effect at the minute parts such as a milling function of a mill and an ultrasonic wave. Examples of the disperser include an ultrasonic homogenizer (US series) of Nissei Corporation and Super Mill (HM-15) of Inoue MFG., Inc. The forcibly dispersed aggregates become coated particles having an average particle diameter of 5 to 1,000 nm, which are the silica particles of which surfaces are coated with the vinyl alcohol-based polymer, and are stabilized as dispersed matters in the water medium. The hydrophilicity is not exhibited when the average particle diameter is less than 5 nm, while the coating workability is deteriorated when the average particle diameter exceeds 1,000 nm.

Various additives may be used for the hydrophilization treatment agent as required. Examples of the additives include an antibacterial agent, a lubricant, a surfactant, a pigment, a dye, and an inhibitor for imparting antirust property.

With the use of the preferred hydrophilization treatment agent, the hydrophilicity of the hydrophilic film is ensured by irregularity of the silica particles, and also it is unlikely that the coated silica particles are directly exposed or discharged due to the condensed water even if the hydrophilic film is somewhat deteriorated after a long use. Therefore, the hydrophilicity durability of the hydrophilic film is high. Further, since the silica particles are coated, generation of the dusty odor specific to silica and odor caused by bacteria adsorbed by silica is suppressed.

In the hydrophilization treatment step, dipping, spraying, or the like may be employed as is the case with the chemical conversion treatment step as a method for bringing the hydrophilization treatment agent into contact with the chemical conversion film without particular limitation, and the dipping is preferred since the heat exchanger has the complicated shape as described in the foregoing. A temperature of the hydrophilization treatment agent may preferably be 10° C. to 50° C., and a treatment time may preferably be 3 seconds to 5 minutes. It is possible to adjust a coating amount of the hydrophilic film by adjusting a deposition amount of the hydrophilization treatment agent film to be formed on the chemical conversion film. In the hydrophilization treatment step, it is preferable to form the hydrophilization treatment agent film on the chemical conversion film in such a manner that the coating amount of the hydrophilic film is 0.1 to 3 g/m² (more preferably 0.2 to 1 g/m²). It is difficult to exhibit the hydrophilization property when the coating amount is less than 0.1 g/m², while productivity tends to be lowered when the coating amount exceeds 3 g/m².

After the hydrophilization treatment step, a second drying step for drying the hydrophilization treatment agent film formed on the chemical conversion film is performed. The second drying step is the step for forming the hydrophilic film on the chemical conversion film by drying the hydrophilization treatment agent film.

A drying temperature and a drying time in the second drying step are not particularly limited, and the drying temperature may preferably be 100° C. to 220° C., more preferably 150° C. to 200° C. The drying time may preferably be 10 to 60 minutes. The film formation property tends to be insufficient when the drying temperature is less than 100° C., while the hydrophilicity durability tends to be deteriorated when the drying temperature exceeds 220° C.

### EXAMPLES

Hereinafter, the present invention will be described in more details by giving examples, but the present invention is not limited only to the examples. Unless otherwise noted, “%”, “part”, and “ppm” in the examples mean “mass %”, “part by mass”, and “mass ppm”.

[Preparation of Surface Treatment Agent]

Surface treatment agents of Examples and Comparative Examples were prepared by blending pure water, zirconium ammonium fluoride, vanadyl nitrate, aluminum sulfate, polyacrylic acid (“Aqualic DL453” of Nippon Shokubai Co., Ltd.), hydrofluoric acid, and zinc sulfate in such a manner that contents of metal ions and so forth in the surface treatment agents are within the ranges shown in Tables 1 and 2. A pH of each of the surface treatment agents was adjusted to be within the range shown in Table 1 or 2 by using a 25% ammonium solution or 67.5% nitric acid. Zirconium ammonium carbonate was used for the surface treatment agent of Comparative Example 4 in place of zirconium ammonium fluoride. Ammonium methavanadate was used as the vanadium element for the surface treatment agents of Comparative Example 7 and Comparative Example 8.

[Coating Amount]

A zirconium coating amount and a vanadium coating amount in the chemical conversion film obtained by each of Examples and Comparative Examples were calculated from measurement results obtained by using a fluorescent X-ray analysis device “XRF-1700” (Shimadzu Corporation).

[Stability of Surface Treatment Agent]

The surface treatment agents of Examples and Comparative Examples are left to stand still at 25° C. for 3 months to confirm generation of an aggregate. The stability evaluation was conducted on the basis of the following 5-grade evaluation. The evaluation results are shown in Tables 1 and 2.

5 points: No aggregate generation for 3 months.

4 points: An aggregate generated in 1 to 3 months.

3 points: An aggregate generated in 1 day to 1 month.

2 points: An aggregate generated in 30 minutes to 1 day.

1 point: An aggregate generated immediately.

[Production of Evaluation Samples 1]

Aluminum plates (“1000-Series Aluminum” (trade name) of Nippon Testpanel Co., Ltd.: 70 mm×150 mm×0.8 mm) was dipped into a bath of tap water heated to 40° C. for 100 seconds and then taken out.

The aluminum plates subjected to the hot water washing were dipped into the surface treatment agents (25° C.) of Examples 1 to 12 and comparative Example 1 to 10, respectively, for 15 seconds to form a surface treatment agent film on a surface of each of the aluminum plates. A deposit amount of each of the surface treatment agents was adjusted in such a manner that a zirconium content and a vanadium content in a chemical conversion film are within the ranges shown in Table 1 or 2.

The aluminum plates in each of which the surface treatment agent film was formed on a surface were dried under the conditions of 170° C. and 30 minutes. By the drying, the chemical conversion films were formed on the surfaces of the aluminum plates.

The aluminum plates on which the chemical conversion films were formed were air-cooled at a room temperature (25° C.) for 30 minutes and then were dipped into a hydrophilization treatment agent (polyvinyl alcohol/silica-based hydrophilization treatment agent, “Surfalucort 1100” of Nippon Paint Co., Ltd.) at 25° C. for 30 seconds to form a hydrophilization treatment agent film on each of the chemical conversion films, followed by drying under the conditions of 170° C. for 30 minutes, thereby forming a hydrophilic film on each of the chemical conversion films. Evaluation Samples 1 were obtained as described above.

[White Rust Resistance Evaluation]

Evaluation Samples 1 were placed upright in a saline water spraying machine and were left to stand still in the machine for 480 hours. After that, Evaluation Samples 1 were taken out of the machine and then were washed with pure water. Evaluation Samples 1 were then dried in a drying furnace at 80° C. for 10 minutes, and a white rust area on each of the surfaces was evaluated. The evaluation was conducted based on the following 5 grades. Results of the evaluation are shown in Tables 1 and 2.

5 points: A white rust area was less than 10%.

4 points: A white rust area was 10% or more and less than 25%.

3 points: A white rust area was 25% or more and less than 50%.

2 points: A white rust area was 50% or more and less than 75%.

1 point: A white rust area was 75% or more and 100% or less.

[Evaluation of Hydrophilicity]

An adhesive tape was attached to each of Evaluation Samples 1 and Evaluation Samples 1 which were caused to deteriorate by immersing in pure water for 1 week at a room temperature and then was peeled off. 2 μl of pure water was placed on each of the tape-peeled portions to measure a contact angle. The contact angle measurement was conducted by using an automatic contact angle meter “CA-Z” (Kyowa Interface Science Co., Ltd.). Results are shown in Tables 1 and 2. A degree of 30° or less was evaluated to be good in the hydrophilicity evaluation.

[Production of Evaluation Samples 2]

Evaluation Samples 2 were produced in the same manner as in Evaluation Examples 1 except for changing the aluminum plates (“1000-Series Aluminum” (trade name) of Nippon Testpanel Co., Ltd.: 70 mm×150 mm×0.8 mm) to anti-corrosion flux-brazed evaporators for automotive air conditioners (NB evaporators).

[Evaluation of Odor]

Odor of each of Evaluation Samples 2 and Evaluation Samples 2 which were caused to deteriorate by immersing into water for 168 hours was confirmed and evaluated based on 6 grades. Results are shown in Tables 1 and 2. 2 points or less was evaluated to be good in the odor evaluation.

0 point: No odor.

1 point: Very weak odor was perceived.

2 points: Weak odor was perceived.

3 points: Odor was perceived.

4 points: Strong odor was perceived.

5 points: Very strong odor was perceived.

TABLE 1

| | | Example | | | | | | | | | | | |
|---|---|---|---|---|---|---|---|---|---|---|---|---|---|
| | | 1 | 2 | 3 | 4 | 5 | 6 | 7 | 8 | 9 | 10 | 11 | 12 |
| Concentration | Al | 500 | 100 | 25 | 10 | 8000 | 500 | 500 | 50 | 250 | 100 | 500 | 500 |
| of each | Zr | 10000 | 800 | 500 | 200 | 80000 | 10000 | 10000 | 1200 | 1000 | 1200 | 12000 | 10000 |
| component in | V | 8000 | 550 | 100 | 200 | 80000 | 8000 | 8000 | 800 | 1000 | 2400 | 2000 | 8000 |
| surface | F | 12500 | 1000 | 625 | 250 | 100000 | 12500 | 12500 | 1300 | 1250 | 1300 | 15000 | 12500 |
| treatment | Polyacrylic acid (PAA) | 10000 | 5500 | 300 | 200 | 80000 | 10000 | 10000 | 1000 | 1000 | 2000 | 10000 | 10000 |
| agent (ppm) | Zn | 0 | 0 | 0 | 0 | 0 | 0 | 0 | 0 | 0 | 0 | 0 | 500 |
| pH of surface treatment agent | | 1.5 | 1.8 | 1.1 | 2.1 | 1.7 | 0.8 | 2.5 | 1.9 | 1.7 | 1.7 | 1.6 | 1.5 |
| Ratio of each | Zr/Al | 20.0 | 8.0 | 20.0 | 20.0 | 10.0 | 20.0 | 20.0 | 24.0 | 4.0 | 12.0 | 24.0 | 20.0 |
| component in | Zr/V | 1.3 | 1.5 | 5.0 | 1.00 | 1.0 | 1.3 | 1.3 | 1.5 | 1.0 | 0.5 | 6.0 | 1.3 |
| surface | Zr/F | 0.8 | 0.8 | 0.8 | 0.80 | 0.8 | 0.8 | 0.8 | 0.9 | 0.8 | 0.9 | 0.8 | 0.8 |
| treatment | V/Al | 16.0 | 5.5 | 4.0 | 20.0 | 10.0 | 16.0 | 16.0 | 16.0 | 4.0 | 24.0 | 4.0 | 16.0 |
| agent | (Zr + V)/PAA | 1.8 | 0.2 | 2.0 | 2.0 | 2.0 | 1.8 | 1.8 | 2.0 | 2.0 | 1.8 | 1.4 | 1.8 |
| Chemical | Zr | 80 | 25 | 12 | 7 | 950 | 80 | 80 | 35 | 30 | 35 | 80 | 80 |
| conversion | V | 65 | 20 | 5 | 7 | 950 | 65 | 65 | 25 | 30 | 70 | 20 | 65 |
| film coating | | | | | | | | | | | | | |
| amount (mg/m²) | | | | | | | | | | | | | |
| Evaluation | White rust resistance | 5 | 5 | 4 | 4 | 5 | 4 | 5 | 5 | 5 | 5 | 4 | 5 |
| results | Stability of surface | 5 | 5 | 5 | 5 | 3 | 5 | 4 | 4 | 4 | 4 | 5 | 5 |
| | treatment agent | | | | | | | | | | | | |
| | Odor | 1 | 1 | 2 | 2 | 2 | 2 | 2 | 2 | 1 | 2 | 1 | 1 |
| | Hydrophilicity/ | 20 | 20 | 20 | 20 | 20 | 25 | 20 | 20 | 20 | 20 | 20 | 20 |
| | contact angle (°) | | | | | | | | | | | | |

TABLE 2

| | | Comparative Example | | | | | | | | | |
|---|---|---|---|---|---|---|---|---|---|---|---|
| | | 1 | 2 | 3 | 4 | 5 | 6 | 7 | 8 | 9 | 10 |
| Concentration | Al | 500 | 500 | 0 | 500 | 500 | 500 | 500 | 500 | 500 | 500 |
| of each | Zr | 0 | 10000 | 10000 | 10000 | 10000 | 10000 | 10000 | 10000 | 10000 | 10000 |
| component in | V | 8000 | 0 | 8000 | 8000 | 8000 | 8000 | 8000 | 8000 | 8000 | 8000 |
| surface | F | 0 | 12500 | 12500 | 0 | 12500 | 12500 | 12500 | 12500 | 12500 | 12500 |
| treatment | Polyacrylic acid (PAA) | 10000 | 10000 | 10000 | 10000 | 0 | 10000 | 0 | 10000 | 10000 | 0 |
| agent (ppm) | Polyvinyl | 0 | 0 | 0 | 0 | 0 | 0 | 10000 | 0 | 0 | 10000 |
| | alcohol (PVA) | | | | | | | | | | |
| pH of surface treatment agent | | 2.5 | 1.9 | 1.4 | 2.4 | 1.5 | 4.0 | 4.0 | 2.0 | 8.0 | 2.0 |
| Ratio of each | Zr/Al | 0.0 | 20.0 | 0.0 | 20.0 | 20.0 | 20.0 | 20.0 | 20.0 | 20.0 | 20.0 |
| component in | Zr/V | 0.0 | 0.0 | 1.3 | 1.3 | 1.3 | 1.3 | 1.3 | 1.3 | 1.3 | 1.3 |
| surface | Zr/F | 0.0 | 0.8 | 0.8 | 0.0 | 0.8 | 0.8 | 0.8 | 0.8 | 0.8 | 0.8 |
| treatment | V/Al | 16.0 | 0.0 | 0.0 | 16.0 | 16.0 | 16.0 | 16.0 | 16.0 | 16.0 | 16.0 |
| agent | (Zr + V)/PAA | 0.8 | 1.0 | 1.8 | 1.8 | 0.0 | 1.0 | 0.0 | 1.0 | 1.0 | 1.0 |
| Chemical | Zr | 0 | 50 | 50 | 0 | 2 | 75 | 0 | 0 | 75 | 50 |
| conversion | V | 0 | 0 | 50 | 0 | 2 | 60 | 0 | 0 | 60 | 40 |
| film coating | | | | | | | | | | | |
| amount (mg/m2) | | | | | | | | | | | |
| Evaluation | White rust resistance | 1 | 2 | 1 | 1 | 1 | 3 | 4 | 1 | 1 | 1 |
| results | Stability of surface | 5 | 5 | 5 | 1 | 5 | 1 | 1 | 1 | 4 | 3 |
| | treatment agent | | | | | | | | | | |
| | Odor | 3 | 3 | 3 | 3 | 3 | 3 | 3 | 3 | 3 | 3 |
| | Hydrophilicity/ | 35 | 20 | 20 | 35 | 30 | 20 | 30 | 35 | 30 | 25 |
| | contact angle (°) | | | | | | | | | | |
| | Remarks | *Peeling | | | *Peeling | | | *Peeling | *Peeling | | |

“*Peeling” means interfacial pealing at an interface between the surface and the coating type chemical conversion film of the aluminum heat exchanger.

As is apparent from Tables 1 and 2, it was confirmed that it is possible to impart the excellent antirust property to the chemical conversion film and to suppress generation of odor derived from the metals such as zirconium by using the surface treatment agent for the aluminum heat exchanger including the zirconium element, the vanadium element, the fluorine element, the aluminum element, and the acrylic polymer, in which the concentration of the zirconium element is 100 to 100,000 mass ppm in terms of zirconium; the concentration of the vanadium element in terms of vanadium is 50 to 100,000 mass ppm; the concentration of the fluorine element is 125 to 125,000 mass ppm; the concentration of the aluminum element in terms of aluminum is 5 to 10,000 mass ppm; the concentration of the acrylic polymer is 100 to 100,000 mass ppm; and the pH is 0.5 to 3. Also, since the use of the surface treatment agent of the present invention eliminates the need for the pickling step for removing the oxide film on the surface of the aluminum heat exchanger, it is possible to form the chemical conversion film on the surface of the aluminum heat exchanger by using a simpler equipment as compared to the conventional examples.

### INDUSTRIAL APPLICABILITY

According to the surface treatment agent for the aluminum heat exchanger and the surface treatment method using the surface treatment agent, it is possible to impart the excellent antirust property to the chemical conversion film and to suppress generation of odor and to suppress odor generated from the chemical conversion film. Further, it is unnecessary to remove the oxide film on the surface of the aluminum heat exchanger when forming the chemical conversion film. Therefore, the surface treatment agent and the surface treatment method of the present invention are suitably used for the surface treatments of the aluminum heat exchangers for air conditioners.

1. A surface treatment agent for an aluminum heat exchanger, comprising:
a zirconium element;
at least one vanadium element selected from a group consisting of vanadyl sulfate, vanadyl nitrate, and vanadyl phosphate;
an acrylic polymer obtainable by polymerizing a monomer including at least one kind selected from a group consisting of acrylic acid, methacrylic acid, and derivatives thereof;
an aluminum element; and
a fluorine element; wherein
a concentration of the zirconium element is 100 to 100,000 mass ppm in terms of zirconium;
a concentration of the vanadium element in terms of vanadium is 50 to 100,000 mass ppm;
a concentration of the polymer is 100 to 100,000 mass ppm;
a concentration of the aluminum element in terms of aluminum is 5 to 10,000 mass ppm;a concentration of the fluorine element is 125 to 125,000 mass ppm; and
a pH is 0.5 to 3.

2. The surface treatment agent for an aluminum heat exchanger according to claim 1, wherein:
a ratio of the concentration of the zirconium element in terms of zirconium to the concentration of the aluminum element in terms of aluminum (Zr/Al) is 4/1 to 24/1;
a ratio of the concentration of the zirconium element in terms of zirconium to the concentration of the vanadium element in terms of vanadium (Zr/V) is 1/2 to 6/1;
a ratio of the concentration of the zirconium element in terms of zirconium to the concentration of the fluorine element (Zr/F) is 1/2 to 9/10;
a ratio of the concentration of the vanadium element in terms of vanadium to the concentration of the aluminum element in terms of aluminum (V/Al) is 4/1 to 24/1; and
a ratio of a sum of the concentration of the zirconium element in terms of zirconium and the concentration of the vanadium element in terms of vanadium to the polymer concentration ((Zr+V)/acrylic polymer) is 1/10 to 2.5/1.

3. A surface treatment method for an aluminum heat exchanger, comprising:
a chemical conversion treatment step for bringing the surface treatment agent for the aluminum heat exchanger according to claim 1 into contact with an aluminum heat exchanger having an oxide film on a surface; and
a first drying step for forming a chemical conversion film on the surface by heating and drying the aluminum heat exchanger which underwent the chemical conversion treatment step.

4. The surface treatment method for an aluminum heat exchanger according to claim 3, wherein:
a content of the zirconium element in the chemical conversion film is 1 to 1,000 mg/m²; and
a content of the vanadium element in the chemical conversion film is 1 to 1,000 mg/m².

5. The surface treatment method for an aluminum heat exchanger according to claim 3, further comprising:
a hydrophilization treatment step for bringing the aluminum heat exchanger which underwent the first drying step into contact with a hydrophilization treatment agent; and
a second drying step for forming a hydrophilic film on the chemical conversion film by heating and drying the aluminum heat exchanger which underwent the hydrophilization treatment step.

6. A surface treatment method for an aluminum heat exchanger, comprising:
a chemical conversion treatment step for bringing the surface treatment agent for the aluminum heat exchanger according to claim 2 into contact with an aluminum heat exchanger having an oxide film on a surface; and
a first drying step for forming a chemical conversion film on the surface by heating and drying the aluminum heat exchanger which underwent the chemical conversion treatment step.

7. The surface treatment method for an aluminum heat exchanger according to claim 6, wherein:
a content of the zirconium element in the chemical conversion film is 1 to 1,000 mg/m²; and
a content of the vanadium element in the chemical conversion film is 1 to 1,000 mg/m².

8. The surface treatment method for an aluminum heat exchanger according to claim 6, further comprising:
a hydrophilization treatment step for bringing the aluminum heat exchanger which underwent the first drying step into contact with a hydrophilization treatment agent; and
a second drying step for forming a hydrophilic film on the chemical conversion film by heating and drying the aluminum heat exchanger which underwent the hydrophilization treatment step.

9. The surface treatment method for an aluminum heat exchanger according to claim 4, further comprising:
a hydrophilization treatment step for bringing the aluminum heat exchanger which underwent the first drying step into contact with a hydrophilization treatment agent; and
a second drying step for forming a hydrophilic film on the chemical conversion film by heating and drying the aluminum heat exchanger which underwent the hydrophilization treatment step.

10. The surface treatment method for an aluminum heat exchanger according to claim 6, further comprising:
a hydrophilization treatment step for bringing the aluminum heat exchanger which underwent the first drying step into contact with a hydrophilization treatment agent; and
a second drying step for forming a hydrophilic film on the chemical conversion film by heating and drying the aluminum heat exchanger which underwent the hydrophilization treatment step.
